(19) United States
(12) Patent Application Publication
(10) Pub. No.: US 2009/0031632 A1
(43) Pub. Date: Feb. 5, 2009

(54) Automatic system for folding wings of automatic revolving door

(76) Inventor: Bok Kwon Wang, Gyeonggi-do (KR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 11/989,659

(22) PCT Filed: May 24, 2006
(86) PCT No.: PCT/KR2006/001955

§ 371 Date: Jan. 29, 2008

(30) Foreign Application Priority Data
Jul. 29, 2005 (KR) 10-2005-0069369

(51) Int. Cl. E05D 15/02

(52) U.S. Cl. 49/44

(57) ABSTRACT

An automatic folding structure of a revolving wing for an automatic revolving door having a dispersion unfolding structure is provided, in which a thread shaft rotated by an operation motor is longitudinally formed at an upper side of a crossbar crossing an inner body, and a moving member which moves based on a rotation of the thread shaft is engaged at the thread shaft, and the moving member is connected with the moving rod of a slider formed at the revolving wing, and the revolving wing is automatically folded or unfolded based on the movements of the moving member and the slider by rotating the thread shaft with the driving operation of the operation motor, so that the opening and recovering states are variably performed with respect to the revolving wing.

### TECHNICAL FIELD

The present invention relates to an automatic revolving door installed at an entrance of a building, and in particular to an automatic folding structure of a revolving wing for an automatic revolving door having a dispersion unfolding structure in which an automatic unfolding structure based on an operation motor and a thread shaft is provided to a revolving door which is fully exploded toward a transparent wall member, so that an automatic unfolding operation of a revolving wing as well as an automatic returning operation can be achieved with a simplified structure for thereby doubling the use of convenience of an automatic revolving door.

### BACKGROUND ART

Generally, a revolving door is installed at an entrance of a building, while passenger and various things passing through the revolving door.

The people who want to pass through the revolving door push the revolving wing, and the rotary shaft is rotated, so that the people can pass through the revolving door.

Recently, a certain driving force apparatus is installed at the rotary shaft, and a detection sensor is installed at the entrance part. When people get access to the door, the detection sensor detects the people, and power is applied to the driving force apparatus, so that the rotary shaft is automatically rotated, whereby the people can directly pass through the revolving door resulting in overcoming the inconveniences.

In particular, in the conventional revolving door and the automatic revolving door, things or part of clothes may be caught between the ends of the revolving wings and the inner surface of the transparent wall for thereby causing safety accident. In case that a long thing passes through the revolving door, it cannot pass through the revolving due to the formation angle of the revolving wing.

Recently, there is provided a structure in which the revolving wings are folded in the direction of one side or both sides from the rotary shaft. With the above structure, when safety accident occurs, a certain safety measurement can be performed by quickly folding a corresponding revolving wing. In case that a long thing or item passes through the revolving door, a corresponding revolving door is folded toward one side from a corresponding revolving wing for thereby providing a safety passage.

However, the above-described revolving door and revolving wing are folded in parallel with respect to the center rotary shaft. With this structure, even when the revolving wing is folded, the revolving wing and the center rotary shaft still remain at the center of the revolving door, so that a desired wider passage is not obtained.

The conventional revolving door or automatic revolving door has a number of revolving wings at the vertical center rotary shaft. When the revolving door is supposed to be folded for obtaining a desired wider passage or for the reason of safety, the revolving wing is formed in a structure that it is folded from the center rotary shaft, so that the center rotary shaft and the revolving wings are still positioned at the inner center of the revolving door, whereby it is impossible to obtain wider passage.

In the case of entertainment stars who need body guard, since the entertainment star should pass through the revolving door alone, it is impossible to achieve a desired security. In a place where vehicles or furniture are displayed or simulate big size things are exhibited, the vehicles or things cannot pass through the revolving door having the center rotary shaft. In this case, it is needed to install an additional entrance passage or a large size opening and closing door.

Therefore, according to the patent application No. 69334 of 2005 invented by the same applicant as the present invention, revolving wings divided at regular angles are hinged at the lower side of the upper plate which is rotated based on the driving motor. The upper outer side of the revolving wing is hinged at the outer end portion of the inner support member of the revolving wing. The upper inner side of the revolving wing is slidably engaged at the lower side of the crossbar of the inner side of the upper plate, so that each revolving wing is unfolded toward the outer wall with respect to the front outer end.

In a state that the center rotary shaft is not provided, it is possible to obtain an inherent function of the revolving door. In the case that it is needed to open the passage of the revolving door, the revolving wing is folded inwards of the wall member, so that the passage of the revolving door is fully opened. With this construction, the entertainment stars or VIPs can pass through the revolving door together with accompanying persons for thereby obtaining a desired security. Large size things such as vehicle or furniture can pass through the revolving door, and it does not need to additionally install an opening and closing door. A number of people can pass through the revolving door at the same time without causing passage of other things, so that the efficiency is maximized.

However, the above automatic revolving door does not have an automatic unfolding structure of the revolving wing which is divided and opened toward a transparent wall member, so that it is needed to manually open each revolving wing or return to its original position.

Even when the automatic unfolding operation is performed using a cylinder or an actuator, it is too expensive. Since over volume is provided, the space efficiency of the facility gets worse.

### DISCLOSURE OF INVENTION

Accordingly, it is an object of the present invention to overcome the problems encountered in the conventional art.

It is another object of the present invention to provide an automatic folding structure of a revolving wing for an automatic revolving door having a dispersion unfolding structure in which a thread shaft rotated by an operation motor is longitudinally formed at an upper side of a crossbar crossing an inner body, and a moving member which moves based on a rotation of the thread shaft is engaged at the thread shaft, and the moving member is connected with the moving rod of a slider formed at the revolving wing, and the revolving wing is automatically folded or unfolded based on the movements of the moving member and the slider by rotating the thread shaft with the driving operation of the operation motor, so that the opening and recovering states are variably performed with respect to the revolving wing, and a simplified construction can be obtained by simply adding the thread shaft and the operation motor, and the automatic unfolding operation can be performed at lower cost, so that very economical operations can be achieved.

### BRIEF DESCRIPTION OF THE DRAWINGS

FIG. 1 is a perspective view illustrating the entire construction of an automatic revolving door having a rotation driving force structure according to the present invention;

FIG. 2 is a side cross sectional view illustrating an automatic revolving door according to the present invention;

FIG. 3 is a plane view illustrating an automatic revolving door according to the present invention;

FIG. 4 is an enlarged perspective view illustrating a major part of an automatic revolving door according to the present invention; and

FIG. 5 is a plane view illustrating an opening and closing operation of a revolving wing of an automatic revolving door according to the present invention.

### BEST MODE FOR CARRYING OUT THE INVENTION

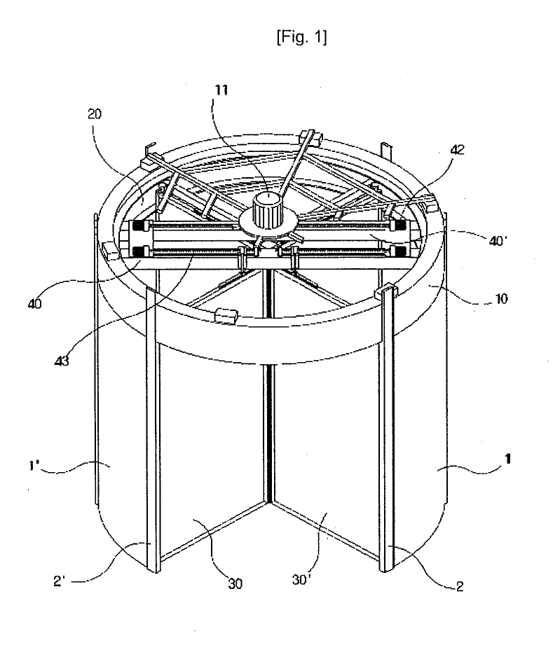

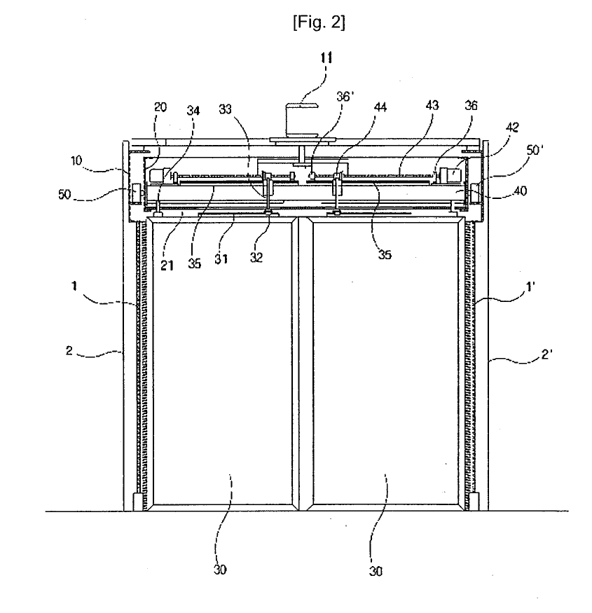

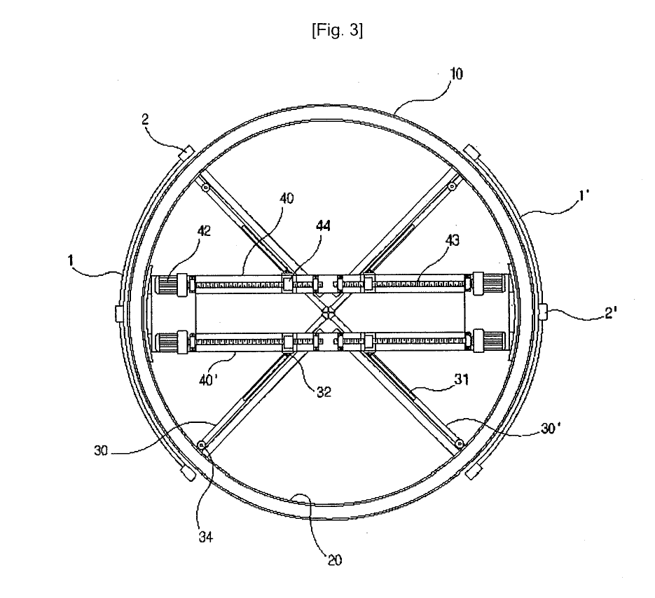

FIG. 1 is a perspective view illustrating the entire construction of an automatic revolving door having a rotation driving force structure according to the present invention, FIG. 2 is a side cross sectional view illustrating an automatic revolving door according to the present invention, and FIG. 3 is a plane view illustrating an automatic revolving door according to the present invention.

In an automatic folding structure of a revolving wing for an automatic revolving door in which an inner body 20 having an upper plate 21 is provided at an inner side of an outer body 10 formed at an upper side of vertical frames 2 and 2′ having transparent wall members 1 and 1′, and a plurality of divided revolving wings 30 and 30′ are provided at the lower side of the upper plate 21, and the inner body 20 and the revolving wings 30 and 30′ are concurrently rotated by the rotational force of the driving motor 11 engaged at the upper side of the outer body 10, and the revolving wings 30 and 30′ are fully unfolded toward the transparent wall members 1 and 1′ along the crossbars 40 and 40′ with respect to the hinge shaft 34 of one upper side, there is provided an automatic folding structure of a revolving wing for an automatic revolving door having a dispersion unfolding structure characterized in that a guide rail 35 is provided at an upper surface of the crossbars 40 and 40′ and a moving member 44 slides along the guide rail 35, and a thread shaft 43 having an operation motor 42 is provided at the end of the guide rail 44 using the shaft receiving parts 36 and 36′ and the thread shafts are opposite at the upper sides of the crossbars 40 and 40′, and the moving member 44 is connected with the moving rod 33 of the slider 32 formed at the upper side of the revolving wings 30 and 30′, and the moving member 44 and the slider 32 are moved based on the movement of the operation motor 42, and the revolving wings 30 and 30′ are automatically rotated and unfolded toward the transparent wall members 1 and 1′ and are returned to their original positions.

In the drawings, reference numerals 50 and 50′ represent revolving rollers.

The operation of the automatic folding structure of a revolving wing for an automatic revolving door having a dispersion unfolding structure according to the present invention will be described with reference to the accompanying drawings.

As shown therein, in the automatic revolving door according to the present invention, a basic structure is constructed in such a manner that vertical frames 2 and 2′ are vertically installed in a building like in the conventional art, and circular transparent wall members 1 and 1′ are provided between the vertical frames 2 and 2′. An entrance part, which does not form the transparent wall members 1 and 1′, is provided at both sides the vertical frames 2 and 2′.

Here, the transparent wall members 1 and 1′ are made of a tempered glass or a high strength synthetic resin.

An outer body 10, which receives various driving parts and operation parts, is provided at the upper sides of the transparent wall members 1 and 1′ and the vertical frames 2 and 2′. A driving motor 11 is engaged at the inner side or upper side of the outer body 10 so as to rotate a plurality of revolving wings 30 and 30′.

An inner body 20 is provided at the inner side of the outer body 10 and is rotated by a rotational driving force from the driving motor 11 together with the revolving wings 30 and 30′ at the inner side of the outer body 10.

The revolving rollers 50 and 50′ provided at the outer portion of the inner body 20 are fixed at the inner side of the outer body 10 so as to allow the inner body 20 to stably and smoothly rotate.

In particular, the revolving wings 30 and 30′ hinged at the inner body 20 rotate from the inner body 20 to the transparent wall members 1 and 1′.

The hinge shaft 34 and the door rail 31 are provided at the upper sides of the revolving wings 30 and 30. The hinge shaft 34 is hinged at the inner wall of the inner body 20, so that the divided revolving wings 30 and 30′ rotate toward the transparent wall members 1 and 1′ along the hinge shaft 34.

The door rail 31 provided at the front ends of the revolving wings 30 and 30′ provides the revolving wings 30 and 30′ with stable support and unfolding operation, with the revolving wings 30 and 30′ being supported by the hinge shaft 34.

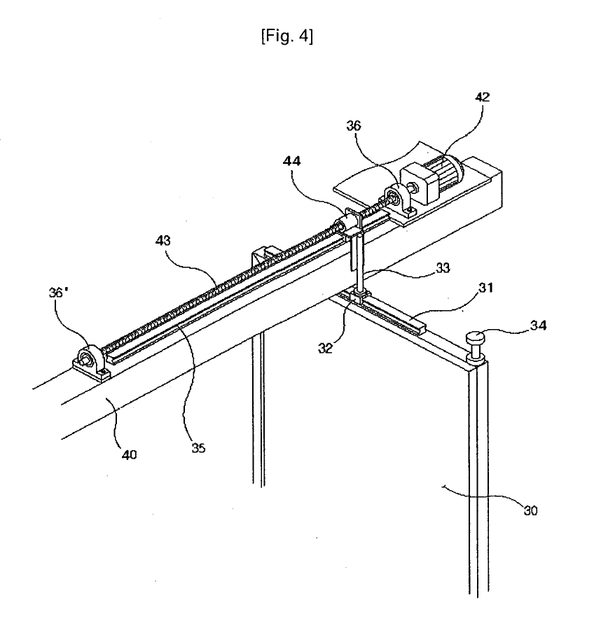

As shown in FIG. 4, the slider 32 inserted into the door rail 31 is provided with the moving rod 33, and the moving rod 33 is connected with the moving member 44 of the thread shaft 43 engaged at the upper side of the crossbars 40 and 40′ crossing over the inner body 20.

The moving member 44 is inserted into the guide rail 35 horizontally engaged at the upper surface of the crossbars 40 and 40′, and the moving member 44 slides along the thread shaft 43 and the guide rail 35 based on the rotation of the thread shaft 43.

Here, the thread shaft 43 is provided at the upper side of the guide rail 35 and is distanced from the guide rail 35 to the upper side by the shaft receiving parts 36 and 36′ with bearings at their both sides. The operation motor 42 is engaged at the end of the thread shaft 43 so as to drive the thread shaft 43.

Therefore, when the operation motor 42 provided at the end of the thread shaft 43 operates, the thread shaft 43 starts rotating. When the thread shaft 43 is rotated, the moving member 44 threaded with the thread shaft 43 slides in the axial direction of the thread shaft 43.

The slider 32 slips along the door rail 31 of the revolving wings 30 and 30′ by the moving rod 33 which connects the moving member 44 and the revolving wings 30 and 30′.

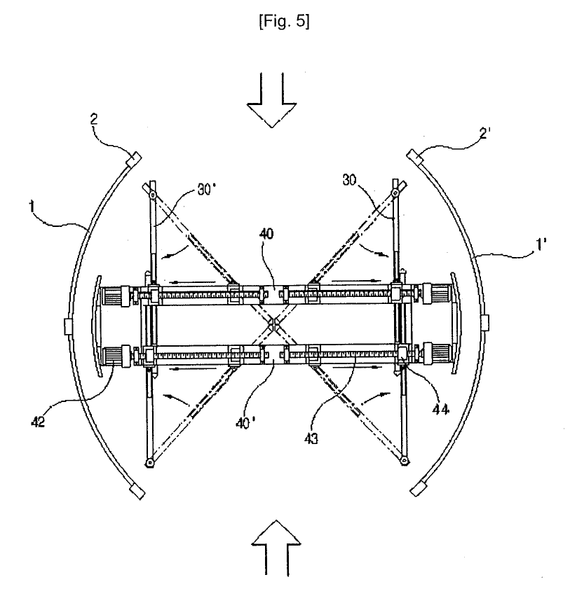

As shown in FIG. 5, the revolving wings 30 and 30′, which are provided with the rotational force from the slider 32, are rotated and unfolded in the direction of the transparent wall members 1 and 1′ with respect to the hinge shaft 34 of the outer front end.

The operation motor 42 and the thread shaft 43 are separately provided at the upper side of the revolving wings 30 and 30′. The four pairs of the operation motors 42 and the thread shafts 43 are oppositely provided at the crossbars 40 and 40′ with respect to the 4-divided revolving wings 30 and 30′, with the crossbars being distanced across the inner body 20.

Therefore, it is possible to preferably unfold only the revolving wings 30 and 30′ by separately operating the operation motor 42. Preferably, the operation motor 42 is arranged to cooperate all together, so that the revolving wings 30 and 30′ are together rotated and unfolded and then returned to their original position for thereby achieving more efficient operation.

### INDUSTRIAL APPLICABILITY

As described above, according to the automatic folding structure of the revolving wings of the automatic revolving door having a dispersion unfolding structure, the thread shaft is rotated by the operation motor, and the revolving wings are automatically unfolded and returned based on the movements of the moving member and slider, so that the opened state or recovering state of the revolving wings can be more conveniently adjusted. Only the thread shaft and operation motor are provided using the conventional crossbar, so that the automatic unfolding structure of the revolving wings can be achieved with more simplification and low cost, and economical system can be obtained.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. In an automatic folding structure of a revolving wing for an automatic revolving door in which an inner body 20 having an upper plate 21 is provided at an inner side of an outer body 10 formed at an upper side of vertical frames 2 and 2′ having transparent wall members 1 and 1′, and a plurality of divided revolving wings 30 and 30′ are provided at the lower side of the upper plate 21, and the inner body 20 and the revolving wings 30 and 30′ are concurrently rotated by the rotational force of the driving motor 11 engaged at the upper side of the outer body 10, and the revolving wings 30 and 30′ are fully unfolded toward the transparent wall members 1 and 1′ along the crossbars 40 and 40′ with respect to the hinge shaft 34 of one upper side, an automatic folding structure of a revolving wing for an automatic revolving door having a dispersion unfolding structure characterized in that a guide rail 35 is provided at an upper surface of the crossbars 40 and 40′ and a moving member 44 slides along the guide rail 35, and a thread shaft 43 having an operation motor 42 is provided at the end of the guide rail 44 using the shaft receiving parts 36 and 36′ and the thread shafts are opposite at the upper sides of the crossbars 40 and 40′, and the moving member 44 is connected with the moving rod 33 of the slider 32 formed at the upper side of the revolving wings 30 and 30′, and the moving member 44 and the slider 32 are moved based on the movement of the operation motor 42, and the revolving wings 30 and 30′ are automatically rotated and unfolded toward the transparent wall members 1 and 1′ and are returned to their original positions.
